(19) United States
(12) Patent Application Publication
(10) Pub. No.: US 2022/0363301 A1
(43) Pub. Date: Nov. 17, 2022

(54) Collapsible Painter Utility Cart and Tool Organizer

(71) Applicant: Paint Poncho, LLC, Dallas, TX (US)

(72) Inventor: Derek Haynes Sholeen, Dallas, TX (US)

(21) Appl. No.: 17/863,370

(22) Filed: Jul. 12, 2022

Related U.S. Application Data
(60) Provisional application No. 63/187,744, filed on May 12, 2021.

(51) Int. Cl. B62B 3/02; B44D 3/04; B44D 3/12; B44D 3/14

(52) U.S. Cl. CPC B62B 3/02; B44D 3/04; B44D 3/125; B44D 3/126; B44D 3/14; B62B 2205/06

(57) ABSTRACT

An apparatus includes a collapsible frame having two hingedly connected frame components that facilitate converting between a folded configuration and an extended configuration. A first platform and a second platform are each hingedly coupled to the collapsible frame, and a detachable paint container has an open top. An upper surface of the first platform includes a first recessed portion that substantially conforms to an outer shape of the detachable paint container and a second recessed portion including substantially concentric circular recesses adapted to conform to an outer shape of at least two different sized paint cans.

### CROSS-REFERENCE TO RELATED APPLICATION

This application claims the benefit of U.S. Provisional Application No. 63/187,744 filed May 12, 2021, which is incorporated herein by reference in its entirety.

### BACKGROUND

This description relates to painting accessories, and more particularly to a painter utility cart and tool organizer.

Painting or staining projects often require bending or kneeling down to load paint applicators (e.g., paint brushes or rollers) with paint or stain. These projects also require several different tools and materials to complete a paint job. Therefore, a painter may develop fatigue or physical ailments while kneeling or bending down throughout the job. Also, searching for disorganized tools can limit the painter's productivity.

### SUMMARY

As described in this specification, a painter's utility cart and tool organizer has a raised work platform with molded areas for a painting tray, a paint can, and tools that enables a painter to keep painting tools conveniently organized in one place. The cart can collapse for easy transport and storage and can have wheels to provide mobility on the job. The collapsible painter utility cart reduces the effort required to load paint applicators while keeping painting tools organized by providing a mobile friendly solution.

### DESCRIPTION OF DRAWINGS

FIG. 1 depicts an implementation of a collapsible utility cart in an extended configuration.

FIGS. 2A and 2B depict a front and side view of a front frame component.

FIGS. 3A and 3B depict a front and side view of a back frame component.

FIG. 4A depicts a perspective view of a top work platform.

FIG. 4B is a perspective view of the top work platform with a detachable roller tray and a detachable paint pail.

FIG. 5 depicts a perspective view of a multiple tool storage organizer.

FIG. 6 depicts the utility cart in a folded or collapsed configuration.

Like reference symbols in the various drawings indicate like elements.

### DETAILED DESCRIPTION

In accordance with aspects described in this specification, a collapsible utility cart offers a convenient way to reduce the effort required to load paint applicators while also keeping painting tools organized by providing a mobile friendly work platform that supports a raised level painting tray, paint can, and tools and keeps necessary tools in one place. For example, the utility cart holds a paint roller tray, paint can, paint bucket or cup, and tools at a height that avoids requiring a user to bend over to load a paint brush or paint roller with paint or to access other tools. The raised work platform of the collapsible painter utility cart can include molded areas for securely holding a painting tray, paint can, and tools. The utility cart can also include a tool organizer and wheels to provide mobility on the job.

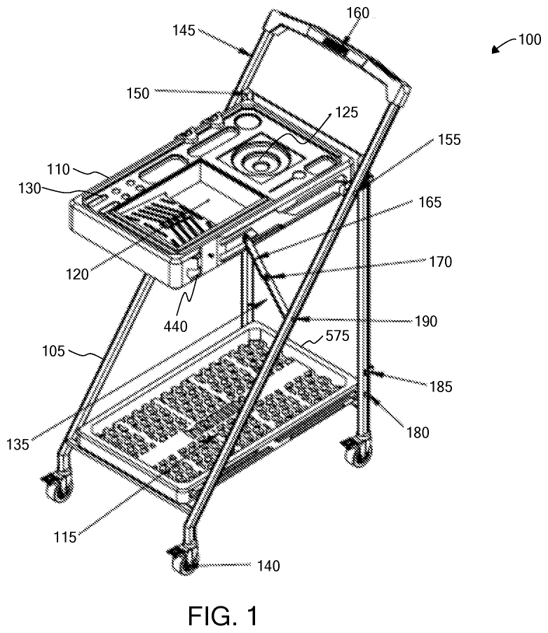

FIG. 1 depicts an implementation of a collapsible utility cart 100 in an extended configuration. The collapsible utility cart 100 includes a cart frame 105 joined together to support two collapsible work platforms 110 and 115. A top work platform 110 includes a paint tray 120, paint can holder 125, and multiple tool holders 130. A bottom work platform 115 can accommodate tool and painting equipment. The cart frame 105 supports the top work platform 110 and the bottom work platform 115 in a horizontal position (e.g., substantially parallel to a floor or other planar support surface when the collapsible frame is in the extended configuration). Locking caster wheels 140 facilitate selectably making the utility cart 100 mobile or stationary. In some implementations, other types of wheels (e.g., non-locking, with or without swivel capabilities, retractable for greater stability and support, etc.) can be used. In some implementations, a multiple tool storage organizer 135 that includes various sizes of pockets for storing tools and supplies can also be attached to the utility cart 100 (e.g., to the back of the cart frame 105 as shown in FIG. 1).

The cart frame 105 includes a plurality of frame components, including at least a front frame component 145 and a back frame component 150 hingedly connected together. For example, the frame components 145 and 150 can be connected together by a bolt, screw or other suitable fastener 155 that allows the frame components 145 and 150 to pivot relative to one another. The front frame component 145 can include a handle 160. The wheels 140 can be connected to the base of the frame components 145 and 150.

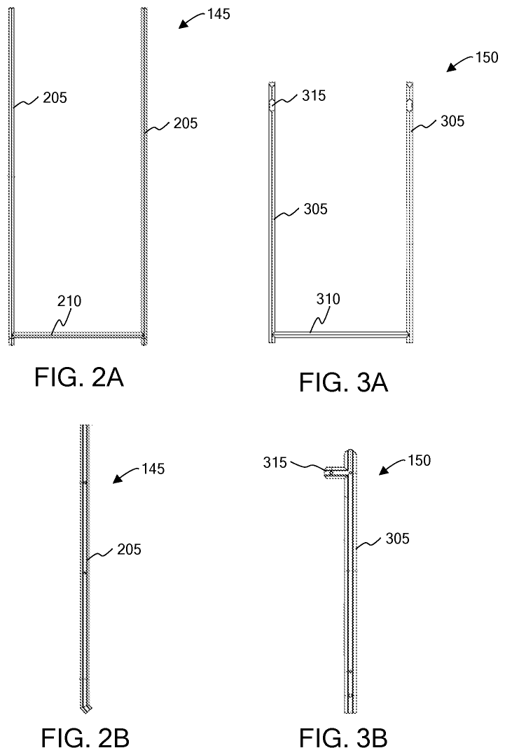

FIGS. 2A and 2B depict a front and side view of the front frame component 145 without the handle 160, including two longitudinal front support shafts 205 and a cross support 210 connected to each of the front support shafts 205. In some implementations, more than one cross support can be used. The handle 160 can, in some implementations serve as a cross support.

FIGS. 3A and 3B depict a front and side view of the back frame component 150, including two longitudinal back support shafts 305 and a cross support 310 connected to each of the second support shafts 305. In some implementations, more than one cross support can be used. The back frame component 150 also includes projecting connectors 315 that can be used to connect the back frame component 150 to the front frame component 145, a connector tab on the multiple tool storage organizer 135, and/or a back end of the top work platform 110.

As shown in FIG. 1, a hinged connector 165 can be connected (e.g., by a bolt, screw, or other suitable fastener 190) to the front frame component 145 and the top work platform 110 to support the top work platform 110 in at least a substantially horizontal position when the utility cart 100 is in the extended configuration, and to enable to top work platform 110 to be folded into a position between the support shafts 205 of the front frame component 145. For example, when the hinged connector 165 is folded using a hinge connection 170, the top work platform 110 can pivot about a connection to the cart frame 105 at a back end of the top work platform 110.

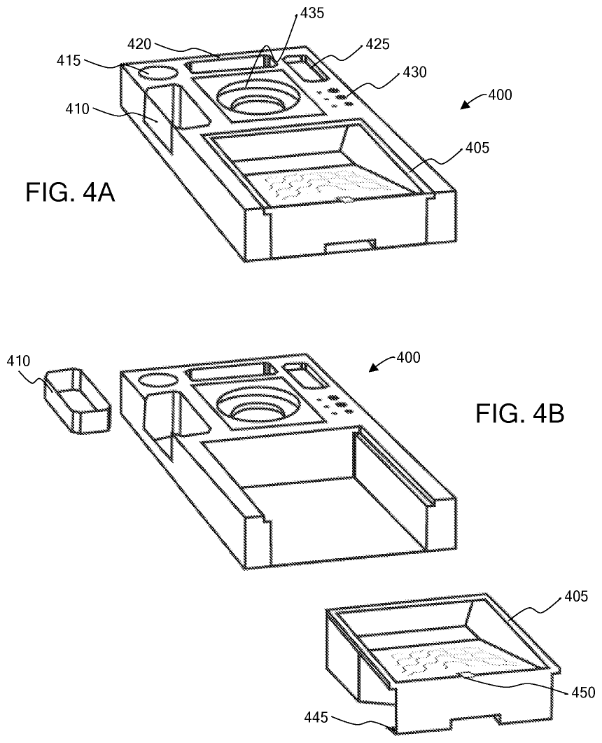

FIG. 4A depicts a perspective view of a top work platform 400. The top work platform 400 can include various features for holding tools, paint, and other supplies. For example, the top work platform 400 can include a paint tray 405 (e.g., a paint roller tray), a paint pail 410 (e.g., for holding trim paint), a cup holder 415, a deep storage compartment 420 (e.g., for holding anything that fits), a magnetic tray 425 (e.g., for holding nuts, bolts, screws, nails, etc., which can be secured in place by a magnet), tool holder slots 430 (e.g., sized to hold screwdrivers, pliers, putty knives, taping knives, paint brushes, painter's tape, paint can openers, etc.), paint can holder recesses 435, and one or more hooks 440 (e.g., to hang a roller frame, paint brush, or any tool that can hang, as shown in FIG. 1). The paint can holder recesses 435 can be sized to fit standard paint can sizes (e.g., quart and gallon cans) and can include concentric, circular, progressively deeper recesses to conveniently fit different sized cans (e.g., to prevent accidents and paint spills by snugly holding paint cans) without occupying too much space on the top work platform 400. In some implementations, similar features can be included in the bottom work platform 115. In some implementations, components of the top work platform 400 can be detachable.

FIG. 4B is a perspective view of the top work platform 400 with a detachable roller tray 405 and a detachable paint pail 410 removed from the top work platform 400. The top work platform 400 can include appropriately sized and shaped recesses (e.g., that substantially conform to outer dimensions of the roller tray 405 and the paint pail 410 to hold the roller tray 405 and the paint pail 410 in place when inserted into the top work platform 400.

The paint tray 405 can be removed, for example, for easy clean-up or for hooking on a ladder using a ladder clip 445. A textured grid pattern in the paint tray 405 can improve paint pick-up, paint distribution, and facilitate smooth wall application, the paint tray 405 can have a deep well for high paint capacity, and the paint tray can accept disposable or removable liners for easy clean up. The paint tray 405 can slide out from the front of the top work platform 400 and can include a roller frame rest 450. The paint tray 405 can be kept secure when folding up the cart by, for example, locking the paint tray 405 in with one or more easy to release tabs.

The detachable paint pail 410 can be used to hold small amounts of paint that a user can easily carry around with one hand. A small size helps reduce hand fatigue, and the paint pail 410 can be used with a paint brush, mini roller, or sponge brush. The paint pail 410 can include ridges on an interior side of the paint pail 410 (e.g., to help with paint pick up). The paint pail 410 can also be used for tool storage, or as a wet tool or brush drip tray. In some implementations, the detachable paint pail 410 can include an embedded magnet that can be used to hold the paint pail 410 in the top work platform 400 (e.g., using a corresponding magnet or ferro-magnetic material in the top work platform 400), to hold a paint brush (i.e., by attraction to metal in the paintbrush), or to otherwise attach the paint pail 410 to a metallic surface.

The bottom work platform 115 can include a large, substantially flat surface to hold tools or paint cans, a raised edge 175 to keep items from sliding off the bottom work platform, and apertures that extend through (or partway, from the top or bottom, through) the bottom work platform 115 to reduce weight and construction material needed. The bottom work platform 115 can be connected to the cart frame 105 by a bolt, screw or other suitable fastener 180 that allows the bottom work platform 115 to pivot relative to the back frame component 150 and to enable to bottom work platform 115 to be folded into a position between the support shafts 305 of the back frame component 150 in the folded configuration.

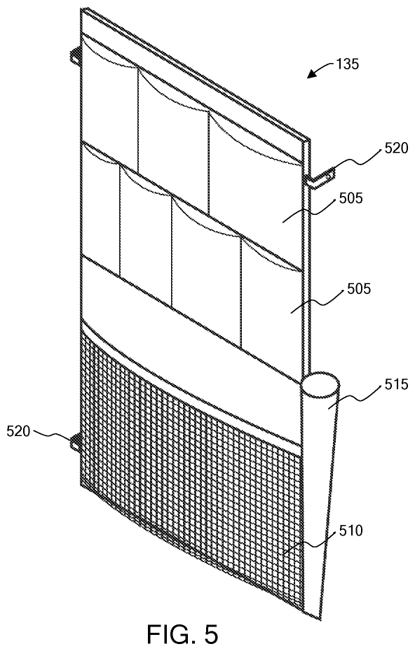

FIG. 5 depicts a perspective view of a multiple tool storage organizer 135. The tool storage organizer 135 can be constructed from weather resistant fabrics or other suitable materials (e.g., materials that are lightweight, versatile, strong, durable, not easily scratched, and waterproof) and can include multiple pockets 505 of different shapes and sizes to hold different types of tools, supplies, and accessories. For example, pockets 505 can be sized and shaped to hold different brush sizes and/or to hold different prep tools. One or more larger pockets 510 can be used to hold paint accessories and/or roller covers. A long, narrow pocket 515 can be used to hold an extension pole, for example. The multiple tool storage organizer 135 further includes tabs 520 for attaching the multiple tool storage organizer 135 to the cart frame 105 (e.g., using screws or other suitable fasteners 185, as shown in FIG. 1).

The various components of the collapsible utility cart 100 can be constructed from any suitable materials. For example, the cart frame 105 can be constructed from lightweight aluminum or another metal or alloy, or can be constructed from other suitable sturdy materials. The handle 160, top work platform 110 or 400 and bottom work platform 115 can be constructed from molded plastic resin or synthetic polymers or other suitable materials.

The collapsible utility cart 100 reduces the effort required to load paint applicators while keeping painting tools organized by providing a mobile friendly solution that has a raised work platform with molded areas for a painting tray, paint can, and tools, and has a multiple tool storage organizer that keeps tools in one place.

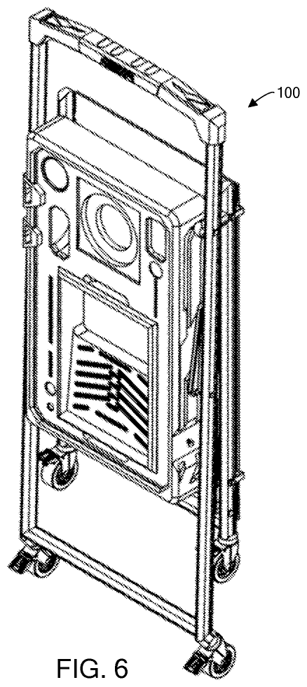

FIG. 6 depicts the utility cart 100 in a folded or collapsed configuration. In some implementations, the utility cart 100 is not collapsible, does not have a bottom work platform 115, does not have caster wheels 140, and/or does not include an attachable tool organizer.

While this specification contains many implementation details, these should not be construed as limitations on the scope of the invention or of what may be claimed, but rather as descriptions of features specific to particular implementations of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, any actions recited in the claims can be performed in a different order and still achieve desirable results.

What is claimed is:

1. An apparatus comprising:
a collapsible frame having at least two hingedly connected frame components, wherein the collapsible frame is adapted for converting between a folded configuration in which the two frame components are substantially parallel along a longitudinal dimension of the frame components and in relatively close proximity to one another and an extended configuration in which at least a portion one of the two frame components extends relatively farther away from the other frame component;
a first platform and a second platform each hingedly coupled to the collapsible frame, wherein each of the first platform and the second platform is adapted to fold into a position in which a longitudinal dimension of the respective first platform and second platform is substantially parallel to the two frame components of the collapsible frame when the collapsible frame is in the folded configuration and to extend in a substantially nonparallel orientation away from at least one of the frame components of the collapsible frame when the collapsible frame is in the extended configuration; and
a detachable paint container having an open top;
wherein an upper surface of the first platform includes a first recessed portion that substantially conforms to an outer shape of the detachable paint container and a second recessed portion including substantially concentric circular recesses adapted to conform to an outer shape of at least two different sized paint cans.

2. The apparatus of claim 1, further comprising a detachable paint roller tray, wherein the detachable paint container is a paint pail and the upper surface of the first platform includes a third recessed portion that substantially conforms to an outer shape of the detachable paint roller tray.

3. The apparatus of claim 1, wherein the detachable paint container comprises a paint pail having a magnet in a side wall of the paint pail.

4. The apparatus of claim 1, wherein the collapsible frame is adapted to support the first platform and the second platform substantially parallel to a planar support surface when the collapsible frame is in the extended configuration.

5. The apparatus of claim 4, further comprising a plurality of wheels attached to the collapsible frame, wherein the plurality of wheels are adapted to contact the planar support surface when the collapsible frame is in the extended configuration.

6. The apparatus of claim 5, wherein at least one of the wheels is a locking caster wheel.

7. The apparatus of claim 4, wherein a first of the two hingedly connected frame components comprises a pair of first support shafts and at least one cross support connected to each of the first support shafts and a second of the two hingedly connected frame components comprises a pair of second support shafts and a handle connected to each of the second support shafts.

8. The apparatus of claim 7 further comprising a hinged connector attached to the second hingedly connected frame components and to the first platform, wherein the hinged connector is adapted to support the first platform in a substantially horizontal position when the collapsible frame is in the extended configuration.

9. The apparatus of claim 1 further comprising a tool organizer having a plurality of pockets.

10. The apparatus of claim 9, wherein the tool organizer is removably attached to the collapsible frame.

11. The apparatus of claim 1 wherein the first platform includes one or more hooks on a side of the first platform.

12. The apparatus of claim 1 wherein the first platform includes one or more slots adapted to hold tools.

13. The apparatus of claim 1 wherein the first platform includes a magnetic tray.

14. The apparatus of claim 1 wherein the detachable paint container comprises a detachable paint roller tray having a clip adapted to removably attach the paint roller tray to a ladder.

15. The apparatus of claim 1 wherein the second platform includes an upper surface with a raised outer lip.

16. The apparatus of claim 1 wherein the first platform and the second platform are constructed from a molded synthetic polymer.

17. The apparatus of claim 16 wherein the second platform includes a plurality of apertures in at least one of the upper or lower surface of the second platform.

18. The apparatus of claim 1, wherein the detachable paint container is a paint pail having ridges on an interior side of the paint pail.
